(19) United States
(12) Patent Application Publication
(10) Pub. No.: US 2026/0116457 A1
(43) Pub. Date: Apr. 30, 2026

(54) NON-MACHINED INTEGRALLY FORMED LOWER JACKET FOR VEHICLE STEERING SYSTEM

(71) Applicant: Steering Solutions IP Holding Corporation, Saginaw, MI (US)

(72) Inventors: Joen C. Bodtker, Flint, MI (US); Melvin L. Tinnin, Clio, MI (US)

(21) Appl. No.: 19/370,442

(22) Filed: Oct. 27, 2025

Related U.S. Application Data
(60) Provisional application No. 63/713,404, filed on Oct. 29, 2024.

(51) Int. Cl. B62D 1/185; B62D 1/181; B62D 1/19

(52) U.S. Cl. CPC B62D 1/185; B62D 1/181; B62D 1/192

(57) ABSTRACT

A steering column assembly includes a lower jacket formed of steel, wherein the lower jacket is not machined. The steering column assembly also includes an upper jacket disposed within the lower jacket and being telescopingly adjustable relative to the lower jacket.

### CROSS-REFERENCE TO RELATED APPLICATION

This application claims the benefits of priority to U.S. Provisional Patent Application Serial No. 63/713,404, filed October 29, 2024, the disclosure of which is incorporated by reference herein in its entirety.

### TECHNICAL FIELD

The following description relates to vehicle steering systems and, more particularly, to a non-machined, integrally formed lower jacket.

### BACKGROUND

A vehicle, such as a car, truck, sport utility vehicle, crossover, mini-van, marine craft, aircraft, all-terrain vehicle, recreational vehicle, or other suitable vehicles, may include various steering system types. Steer-by-wire and driver interface steering are examples of steering system types which may be utilized. These steering system schemes typically include a steering column assembly for translating steering input to an output that interacts with a steering linkage to ultimately cause the vehicle wheels to turn.

In electrically powered adjustable (i.e. telescope and rake) steering column assemblies, a die cast and machined lower jacket is utilized. A process requiring machining of the lower jacket is required, primarily due to draft angles required in the casting process. Some of the machining is due to the need for higher precision in sizes of the jacket features. Particular machined interfaces include the upper jacket locating features, such as a deep bore, the rake mechanism pivot axis, the lower bearing seat, the column pivot axis. The aforementioned machining adds cost to the original casting.

### SUMMARY

According to one aspect of the disclosure, a steering column assembly includes a lower jacket formed of steel, wherein the lower jacket is not machined. The steering column assembly also includes an upper jacket disposed within the lower jacket and being telescopingly adjustable relative to the lower jacket.

According to another aspect of the disclosure, a steering column assembly includes a lower jacket formed of steel, wherein the lower jacket is not machined, wherein the lower jacket is a single, integrally formed component which is not comprised of welded components. The steering column assembly also includes an upper jacket disposed within the lower jacket and being telescopingly adjustable relative to the lower jacket. The steering column assembly further includes a telescope actuator mechanism. The steering column assembly yet further includes a rake actuator adjustment mechanism.

These and other aspects of the present disclosure are disclosed in the following detailed description of the embodiments, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 schematically illustrates a vehicle with a steering system.

FIG. 2 is a perspective, disassembled view of a steering column assembly.

FIG. 3 is a perspective view of a non-machined lower jacket.

FIG. 4 is an end, elevation view of the non-machined lower jacket.

### DETAILED DESCRIPTION

The following discussion is directed to various embodiments of the disclosure. Although one or more of these embodiments may be described in more detail than others, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described, a vehicle, such as a car, truck, sport utility vehicle, crossover, mini-van, marine craft, aircraft, all-terrain vehicle, recreational vehicle, or other suitable vehicles, include various steering systems, for example, steer-by-wire and driver interface steering. These steering systems typically include a steering column assembly for translating steering input to an output that interacts with a steering linkage to ultimately cause the vehicle wheels to turn.

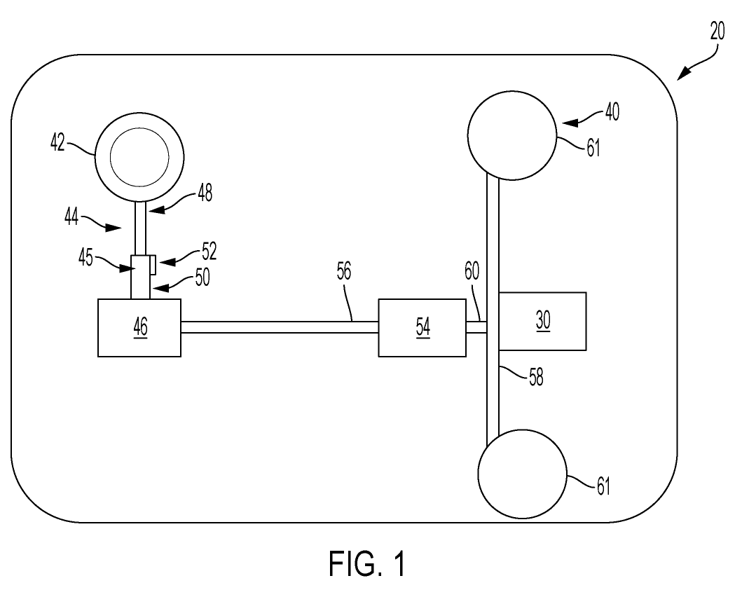

Referring initially to FIG. 1, a vehicle 20 is generally illustrated according to the principles of the present disclosure. The vehicle 20 may include any suitable vehicle, such as a car, a truck, a sport utility vehicle, a mini-van, a crossover, any other passenger vehicle, any suitable commercial vehicle, or any other suitable vehicle. While the vehicle 20 may be a passenger vehicle having wheels and for use on roads, the principles of the present disclosure may apply to other vehicles, such as planes, tractors, boats, or other suitable vehicles. The vehicle 20 may include a propulsion system 30, such as an ignition system, an electronic system, or combinations thereof.

In some embodiments, the vehicle 20 may further include a steering system 40. The steering system 40 may be configured as a driver interface steering system, an autonomous driving system, or a system that allows for both driver interface and autonomous steering. The steering system may include an input device 42, such as a steering wheel, wherein a driver may mechanically provide a steering input by turning the steering wheel. A steering column assembly 44 may include a steering column 45 that extends along a longitudinal axis A from the input device 42 to an output assembly 46. The output assembly 46 may include a pinion shaft assembly, an I-shaft, a cardan joint, steer-by-wire components or any other features conventionally located opposite the input device 42.

The steering column 45 may include at least two axially adjustable portions, for example, an upper jacket 48 and a lower jacket 50 that are axially adjustable with respect to one another. The relative axial movement is described herein as being telescoping, wherein the upper jacket 48 telescopes within the lower jacket 50 over a range of axial positions from an extended column position to a retracted column position. The steering column assembly 44 may include additional portions which provide rake and/or tilt movement.

An energy absorption apparatus 52 is coupled to the upper jacket 48 to provide load absorption settings. During a collapse event, a force may move or collapse the upper jacket 48 along the longitudinal axis A of the steering column 45 and the energy absorption apparatus 52 dissipates at least some of the kinetic energy of the collapsing first jacket 48 and the second jacket 50.

A steering gear assembly 54 may connect to the output assembly 46 via a steering gear input shaft 56. The steering gear assembly 54 may be configured as a rack-and-pinion, a recirculating ball-type steering gear, or any other type of steering gears associated with autonomous and driver-interface steering systems. The steering gear assembly 54 may then connect to a driving axle 58 via an output shaft 60. The output shaft 60 is operably connected to the steering gear assembly 54 such that a rotation of the steering gear input shaft 56 causes a responsive movement of the output shaft 60 and causes the drive axle to turn the wheels 61.

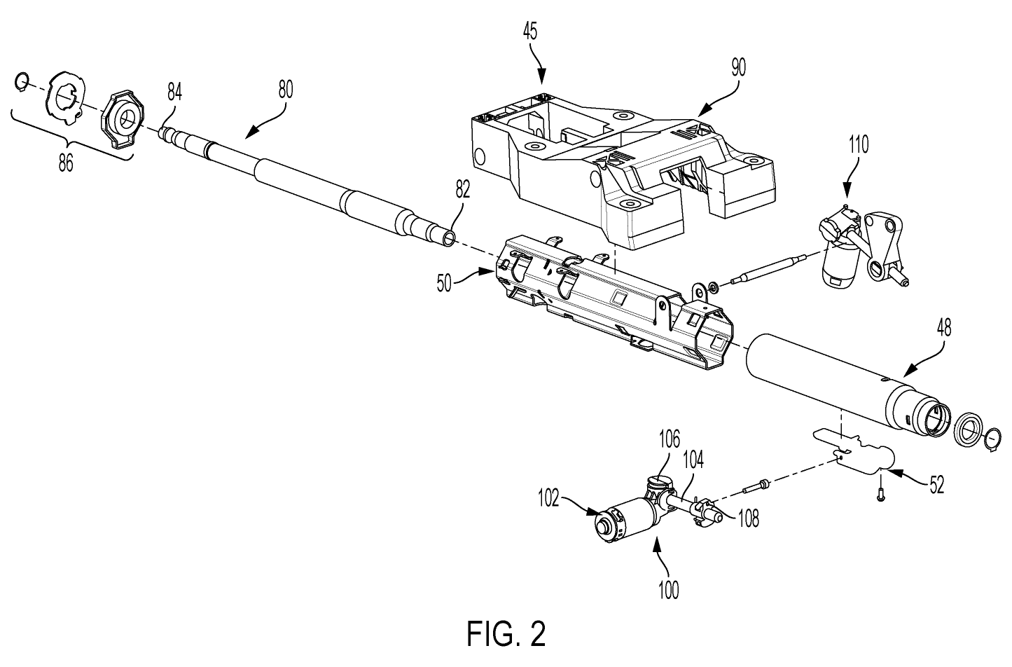

FIG. 2 illustrates a disassembled portion of the steering column assembly 44. In this view, the first jacket 48 is shown removed from the second jacket 50. In assembly, the first jacket 48 is an upper jacket in telescoping engagement within the second jacket 50, which is a lower jacket. A steering shaft assembly 80 extends within both jackets 48, 50, with a first end 82 extending outer of the upper jacket 48 for connection to the steering input device 42. As second end 84 of the steering shaft assembly 80 extends out of the lower jacket 50 and is supported by a lower bearing assembly 86. The lower jacket 50 is operatively coupled to a mounting bracket 90 that is used to mount the steering column assembly 44 to the vehicle structure.

A pair of actuator assemblies facilitate electrically powered adjustment of the steering column assembly 44, specifically a telescope drive assembly 100 and a rake actuator assembly 110.

The telescope drive assembly 100 is a powered actuator which actuates telescoping movement of the upper jacket 48 relative to the lower jacket 50. The telescope drive assembly 100 includes an electric actuator 102, such as an electric motor, that drives rotational movement of a threaded rod 104. A gearbox 106 may facilitate the transfer of power from an output shaft (not shown) of the electric actuator 102 to the threaded rod 104. Rotation of the threaded rod 104 results in translation of a telescope drive nut 108 which is threaded to an outer surface of the threaded rod 104. Translation of the telescope drive nut 108 is generally parallel to the longitudinal axis of the steering column 45.

The rake actuator assembly 110 is utilized to carry out pivoting adjustment of the lower jacket 50. The energy absorption apparatus 52 is operatively coupled to the upper jacket 48 to absorb energy during a collapse event.

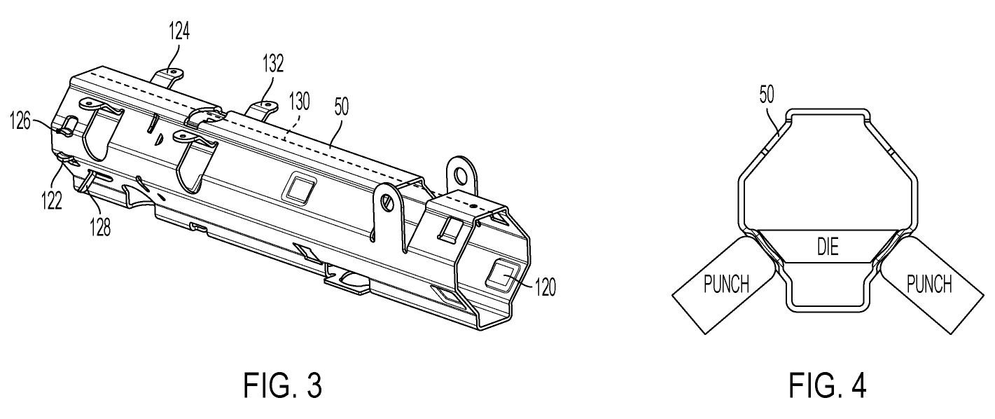

Referring now to FIGS. 3 and 4, the lower jacket 50 is a wrapped steel jacket and no machining is utilized to form the steel jacket. The lower jacket 50 is a single, integrally formed component which is not comprised of welded components to form the lower jacket 50. The lower jacket 50 includes several features which are formed thereon. For example, formed upper jacket support pads 120, formed lower pivot tabs 122, a formed lower bearing seat 124, pierced rake mechanism pivot features 126, assembly error proofing tabs 128, an actuator twist lock attachment aperture, an interlocking zipper seam 130 for the steel wrap, and support legs 132 are provided on the steel jacket (FIG. 3).

Prior electrically powered adjustment steering column lower jackets have not been formed of steel and typically require machining to add the detailed functional features of column jackets. The embodiments disclosed herein require a wrapped steel lower jacket which is not machined after forming. The disclosed embodiments advantageously reduce cost and assembly complexity of the overall steering system by avoiding welding or other joining processes, while achieving the benefits of a steel jacket.

In the embodiments disclosed herein, the lower jacket 50 is formed with a steel stamping that is "wrapped" around the lower jacket. This assists with avoiding any machining inside of the jacket 50 when combined with a de-lashing mechanism, thus effectively eliminating any clearance between the upper jacket 48 and the lower jacket 50. The lower jacket 50 has contact pads stamped into the inner surface. The smaller contact helps to minimize the friction between the jackets 48, 50.

Additionally, multiple features are provided and formed in the lower jacket 50, as described in detail above, without using multiple stampings and/or welding operations. All of the design features required are pierced/stamped out of a single sheet of steel without the need to weld additional stampings. Rigidity is added to the piece by the interlocking zipper seam.

While the invention has been described in detail in connection with only a limited number of embodiments, it is to be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Moreover, any feature, element, component or advantage of any one embodiment can be used on any of the other embodiments. Accordingly, the invention is not to be seen as limited by the foregoing description.

What is claimed is:

1. A steering column assembly comprising:
a lower jacket formed of steel, wherein the lower jacket is not machined; and
an upper jacket disposed within the lower jacket and being telescopingly adjustable relative to the lower jacket.

2. The steering column assembly of claim 1, further comprising an electrically powered adjustment mechanism for adjusting at least one of the upper jacket and the lower jacket.

3. The steering column assembly of claim 2, wherein the electrically power adjustment mechanism comprises a telescope actuator mechanism.

4. The steering column assembly of claim 2, further comprising a rake actuator adjustment mechanism.

5. The steering column assembly of claim 1, wherein the lower jacket is a single, integrally formed component which is not comprised of welded components.

6. The steering column assembly of claim 1, further comprising an energy absorption apparatus operatively coupled to the upper jacket to absorb energy during a collapse event.

7. The steering column assembly of claim 5, wherein the lower jacket includes at least one formed upper jacket support pad as part of the single, integrally formed component.

8. The steering column assembly of claim 5, wherein the lower jacket includes at least one formed lower pivot tab as part of the single, integrally formed component.

9. The steering column assembly of claim 5, wherein the lower jacket includes at least one formed lower bearing seat as part of the single, integrally formed component.

10. The steering column assembly of claim 5, wherein the lower jacket includes at least one pierced rake mechanism pivot feature as part of the single, integrally formed component.

11. The steering column assembly of claim 5, wherein the lower jacket includes at least one assembly error proofing tab as part of the single, integrally formed component.

12. The steering column assembly of claim 5, wherein the lower jacket includes at least one an actuator twist lock attachment aperture as part of the single, integrally formed component.

13. The steering column assembly of claim 5, wherein the lower jacket includes at least one an interlocking zipper seam as part of the single, integrally formed component.

14. The steering column assembly of claim 5, wherein the lower jacket includes at least one support leg as part of the single, integrally formed component.

15. A steering column assembly comprising:
a lower jacket formed of steel, wherein the lower jacket is not machined, wherein the lower jacket is a single, integrally formed component which is not comprised of welded components;
an upper jacket disposed within the lower jacket and being telescopingly adjustable relative to the lower jacket;
a telescope actuator mechanism; and
a rake actuator adjustment mechanism.
